(19) United States
(12) Patent Application Publication
(10) Pub. No.: US 2004/0228121 A1
(43) Pub. Date: Nov. 18, 2004

(54) Ornamental flower with illuminating device for indoor and outdoor use

(76) Inventor: Gary Horng, Taichung (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/623,835

(22) Filed: Jul. 22, 2003

(30) Foreign Application Priority Data
May 12, 2003 (CN) 03251224.4

(51) Int. Cl. F21V 5/00

(52) U.S. Cl. 362/122; 362/806

(57) ABSTRACT

An ornamental flower with illuminating device for indoor and outdoor use includes an illuminating assembly connected to a front end of an ornamental flower. The illuminating assembly includes a light diffusing shell, a light-emitting unit, and a holding member. The light diffusing shell is made of a light-transmissible material and defines an internal space for accommodating the light-emitting unit therein, such that light beams emitted from the light-emitting unit are evenly diffused toward the ornamental flower surrounding the illuminating assembly, making the ornamental flower softly illuminated and looked vivid.

### BACKGROUND OF THE INVENTION

1. Field of the Invention

The present invention relates to an illuminating ornamental flower, and more particularly to an ornamental flower having an illuminating assembly with a light-emitting unit connected thereto, so that the ornamental flower is softly illuminated and looked vivid.

2. Description of the Prior Art

A light-emitting device may be used not only as an illuminating apparatus, but also a decoration. When light beams emitted from the light-emitting unit are specially projected in different manners and/or intensities or when decoration are arranged around the light-emitting unit, the light-emitting unit becomes more valuable for use. There are various products of light-emitting units, and most of them use an incandescent lamp, a power-saving bulb, or a Christmas light as a light source. However, such conventional light-emitting devices could provide limited changes to the light beams emitted therefrom, and mainly used for common illumination.

To enable the emitted light to change variously, there is developed a light-emitting unit using light emitting diodes (LED) as the light source. Since the LED type light-emitting unit is very compact and can provide lighting of different intensities according to requirements, it has been widely employed in various kinds of lighting fixtures, dim lights, etc.

Since the light emitted from the LED type light-emitting unit provides very good light condensing effect and directly projects outward, an intense light spot could usually be seen on the translucent casing of an illuminating device using LED type light emitting unit as the light source. On the other hand, areas on the translucent casing of the illuminating device other than the intense light spot are relatively dark. It gives the illuminating device an inferior sense of sight. When such illuminating device is applied to, for example, an ornamental flower, it fails to softly illuminate the ornamental flower for the same to give a vivid appearance. Moreover, the light-emitting unit of prior art does not include any protective and/or decorative means, such as a lampshade, and would therefore have an adverse influence on an overall beauty of the ornamental flower.

### SUMMARY OF THE INVENTION

It is therefore a primary object of the present invention to provide an ornamental flower with illuminating device for indoor and outdoor use that overcomes drawbacks existed in the conventional illuminating products with LED type light-emitting unit. The illuminating device included in the present invention includes an illuminating assembly adapted to produce soft light beams and make the ornamental flower looked vivid, elegant, and beautiful.

Another object of the present invention is to provide a structurally simple ornamental flower with illuminating device for indoor and outdoor use. The illuminating device includes an illuminating assembly having a light diffusing shell that softens light beams emitted from a light-emitting unit and thereby makes the ornamental flower looked vivid. When the illuminating assembly includes LED type light-emitting units emitting differently colored light beams, a variety of changeful effects may be achieved.

To achieve the objects, the present invention includes an illuminating assembly disposed in the center of an ornamental petal portion. The illuminating assembly comprises at least one light-emitting unit for projecting light, a diffusing shell that is made of light-transmissible material for housing the light-emitting unit and evenly diffusing the light out to the ornamental petal portion, and a holding member which includes a light-emitting unit holder, a connecting sleeve, and a lead holder. The diffusing shell has a plurality of facets, and may be differently configured to match with an appearance of the ornamental flower. The front end of the lead holder is extended into the connecting sleeve to engage with the light-emitting unit holder. The light-emitting unit holder is internally provided with two through holes for the two pins of the light-emitting unit to extend therethrough and to electrically connect to the leads of the power cord extending through the two holes of the lead holder to obtain the working voltage for the light-emitting unit.

With the present invention, the structurally simple light diffusing shell is capable to diffuse and soften light beams emitted from a light-emitting unit, so as to make an ornamental flower illuminated by the emitted light beams looked vivid or even to create a variety of changeful decorating effects. When the illuminating assembly of the present invention is applied to various lighting fixtures, dim lights, etc., an elegant and esthetic effect can be created.

Unlike the conventional LED type light-emitting unit, the illuminating assembly included in the present invention does not form an intense light spot on the outer surface of the light diffusing shell covering the light-emitting unit. The present invention is therefore superior to the prior art.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is an exploded perspective view of an ornamental flower with illuminating device for indoor and outdoor use according to an embodiment of the present invention showing various portions thereof;

FIG. 2 is an exploded perspective view of an illuminating assembly included in the present invention;

FIG. 3 is an exploded side view of the illuminating assembly of FIG. 2;

FIG. 4 is an assembled perspective view of the illuminating assembly of FIG. 2;

FIG. 5 is a cross sectional view taken along line 5-5 of FIG. 4; and

FIG. 6 is a perspective view of a variant of the illuminating assembly of FIG. 2.

### DETAILED DESCRIPTION OF THE PREFERRED EMBODIMENTS

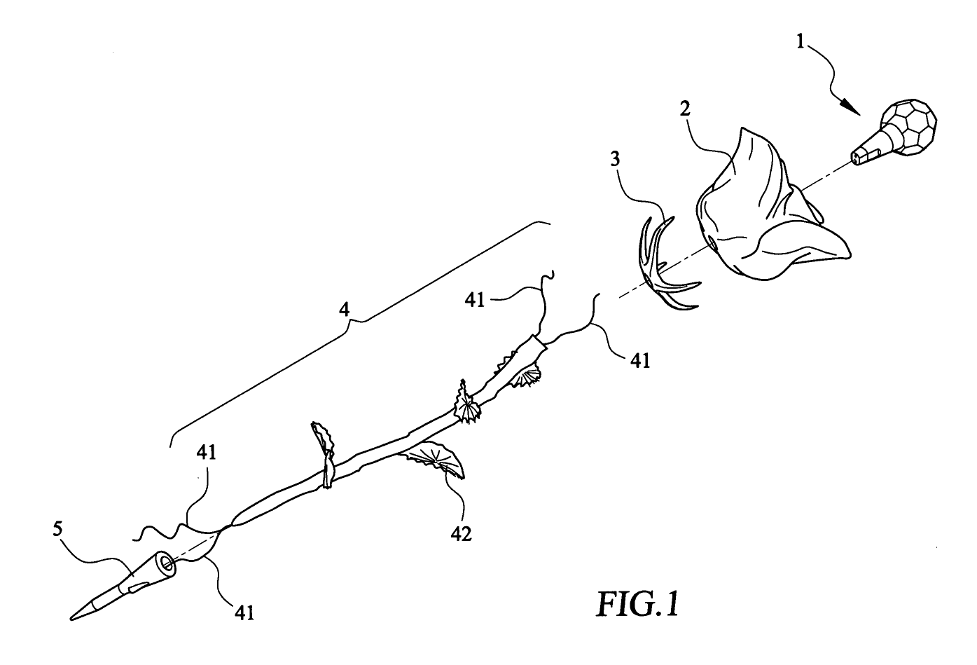

Please refer to FIG. 1 that is an exploded perspective view of an ornamental flower with illuminating device for indoor and outdoor use according to an embodiment of the present invention showing various portions thereof. As shown, the present invention mainly includes an illuminating assembly 1, an ornamental petal portion 2 connected to a rear end of the illuminating assembly 1, an ornamental receptacle portion 3 located behind the petal portion 2, an ornamental peduncle portion 4 located behind the receptacle portion 3, and an insertion rod portion 5 connected to a rear end of the peduncle portion 4. An outer surface of the peduncle portion 4 may be decorated with artificial leaves or painted with suitable patterns or colors to match the petal portion 2, so that the whole invention appears to be highly resembled to real flower. The peduncle portion 4 defines an internal space for leads 41 of a power cord to extend therethrough to supply electric power needed by the present invention. The leads 41 of the power cord also extend through the insertion rod portion 5 to connect to an external power source, so as to obtain a working voltage for the present invention.

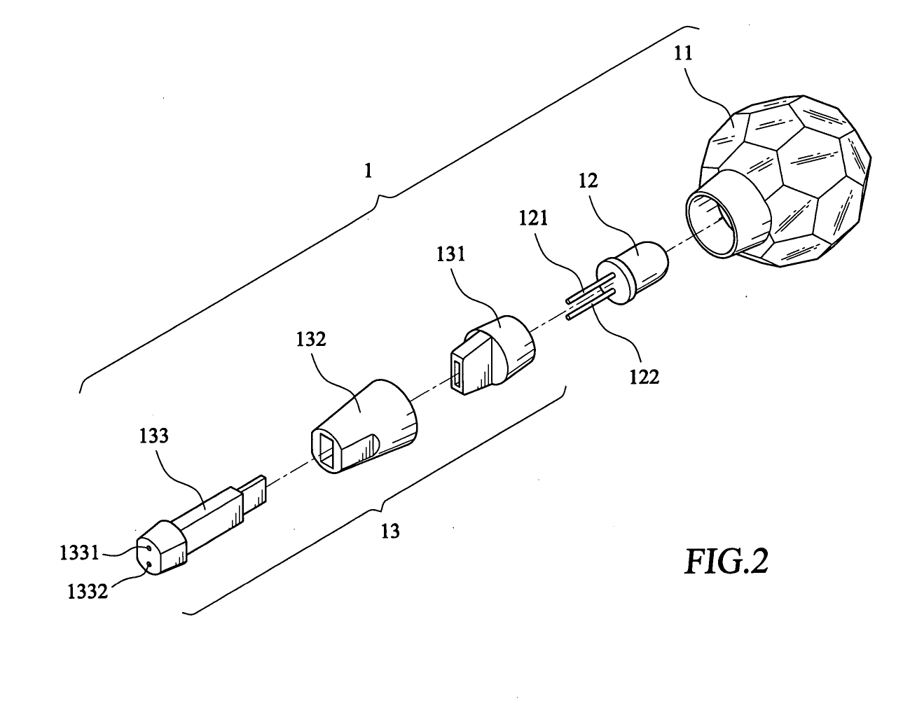

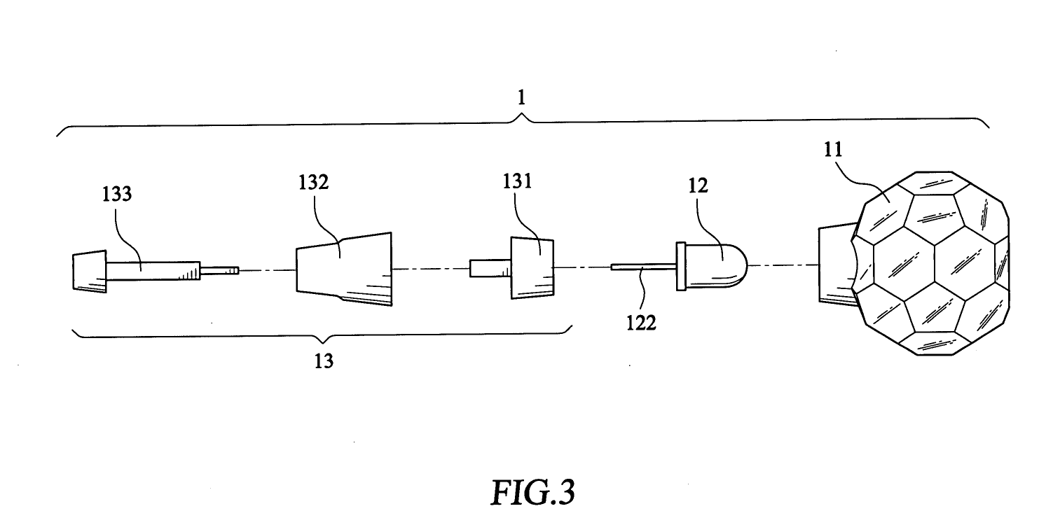

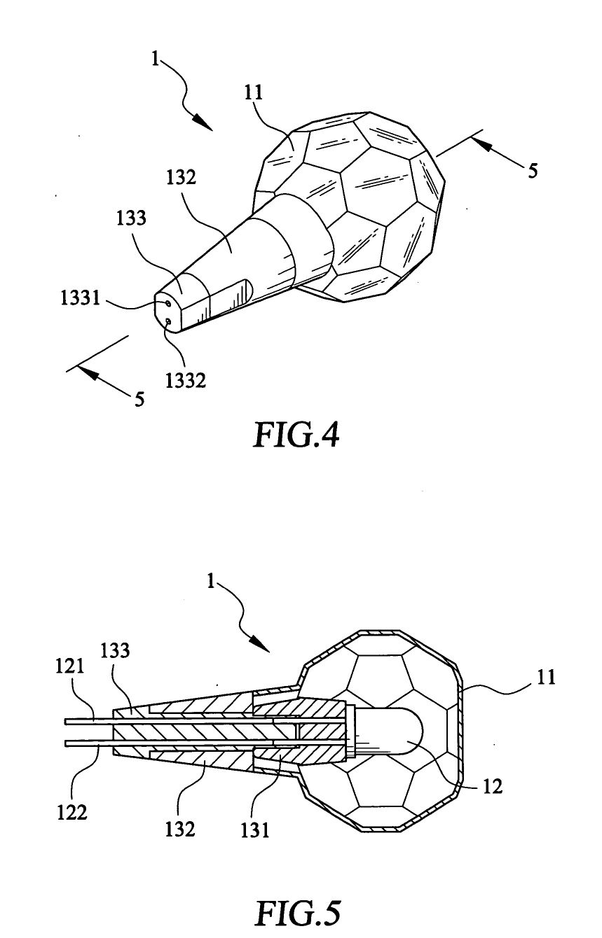

The illuminating assembly 1 represents a pistil or a stamen in the present invention. Please refer to FIG. 2, which is an exploded perspective view of the illuminating assembly 1. The illuminating assembly 1 mainly includes, from front to rear end, a light diffusing shell 11, a light-emitting unit 12, and a holding member 13. The light-emitting unit 12 includes two pins 121, 122, and the holding member 13 includes a light-emitting unit holder 131, a connecting sleeve 132, and a lead holder 133. The lead holder 133 is provided at a rear portion with two through holes 1331, 1332 for the two leads 41 of the power cord to extend therethrough. A front end of the lead holder 133 is extended into the connecting sleeve 132 to engage with the light-emitting unit holder 131. The light-emitting unit holder 131 is internally provided with two through holes for the two pins 121, 122 of the light-emitting unit 12 to extend therethrough to electrically connect to the leads 41 of the power cord and thereby obtain the working voltage for the light-emitting unit 12. The light diffusing shell 11 is made of a light-transmissible material and located at the most front end of the illuminating assembly 1. The light diffusing shell 11 defines an internal space for accommodating the light-emitting unit 12 and the light-emitting unit holder 131 therein, such that the shell 11 is connected at a rear end to the connecting sleeve 132 to form an integral body. FIG. 3 is an exploded side view of the illuminating assembly 1 clearly showing all components thereof. FIG. 4 is an assembled perspective view of the light-emitting unit 12, and FIG. 5 is an assembled cross sectional view taken along line 5-5 of FIG. 4 to better show an internal structure of the illuminating assembly 1 and the way of wiring to obtain the working voltage for the present invention. The light-emitting unit 12 may include light emitting diodes (LED) emitting differently colored light beams to create varied decorating effects.

As mentioned above, the light diffusing shell 11 is made of a light-transmissible material and located at the most front end of the illuminating assembly 1 to evenly diffuse light beams emitted from the light-emitting unit 12. In the illustrated embodiment of the present invention, the shell 11 has a plurality of facets, and may be differently configured to match with an appearance of the ornamental flower.

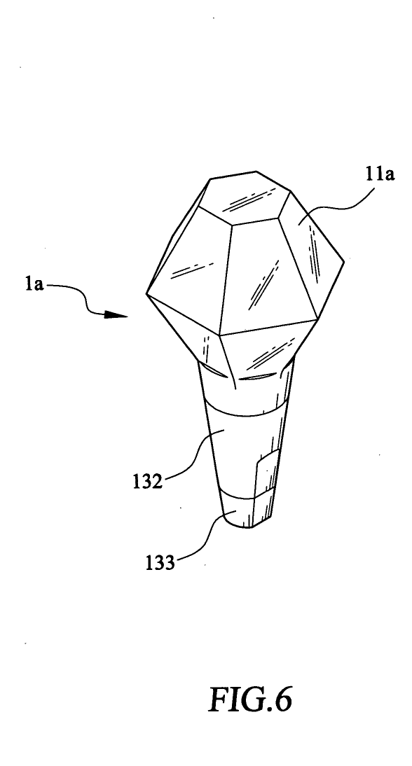

FIG. 6 is an assembled perspective view of a variant of the illuminating assembly for the present invention. In this variant, the illuminating assembly 1a includes a light diffusing shell 11a, a connecting sleeve 132, and a lead holder 132 to show an appearance completely different from that of the illuminating assembly 1 of FIG. 4.

Although the present invention has been described with reference to the preferred embodiment thereof, it is apparent to those skilled in the art that a variety of modifications and changes may be made without departing from the scope of the present invention which is intended to be defined by the appended claims.

What is claimed is:

1. An ornamental flower, comprising:
at least one ornamental petal portion; and
an illuminating assembly, which comprises:
a light diffusing shell;
a light-emitting unit for emitting a light beams; and
a holding member;
wherein the light diffusing shell is made of a light-transmissible material and connected to a most front end of the ornamental flower via the holding member; the light diffusing shell defines an internal space for accommodating the light-emitting unit therein, such that the light beams emitted from the light-emitting unit are evenly diffused and projected toward the at least one ornamental petal portion surrounding the illuminating assembly.

2. The ornamental flower as claimed in claim 1, wherein the light diffusing shell has an outer surface formed into a plurality of facets.

3. The ornamental flower as claimed in claim 1, wherein the light-emitting unit comprises at least one light emitting diode.

4. The ornamental flower as claimed in claim 1, wherein the holding member comprises:
a light-emitting unit holder,
a connecting sleeve; and
a lead holder;
wherein the light-emitting unit holder is internally provided with two through holes for pins of the light-emitting unit to extend therethrough to electrically connect to two leads of a power cord for the ornamental flower and thereby obtain a working voltage for the light-emitting unit, and the lead holder is provided at a rear portion with two through holes for the two leads of the power cord to extend therethrough, and the lead holder has a front end extended into the connecting sleeve to engage with the light-emitting unit holder.
